(19) United States
(12) Patent Application Publication
(10) Pub. No.: US 2015/0142572 A1
(43) Pub. Date: May 21, 2015

(54) SERVING CONTENT BASED ON ONLINE REGISTRATION AND OFFLINE MESSAGES

(71) Applicant: Siddharth Vijayakrishnan, Mountain View, CA (US)

(72) Inventor: Siddharth Vijayakrishnan, Mountain View, CA (US)

(21) Appl. No.: 13/328,712

(22) Filed: Dec. 16, 2011

(51) Int. Cl. G06F 15/16; G06Q 30/02; G06Q 30/08

(52) U.S. Cl. CPC G06Q 30/0261; G06Q 30/0275
USPC 705/14.58; 705/26.3; 709/217

(57) ABSTRACT

Methods, systems, and computer program products are provided for serving content based on online registration and offline messages. One example method includes registering online an entity with a content management system, the registering including storing a location associated with the entity, receiving offline from the entity a message that indicates information for use in a sponsored content item, determining that a user is in proximity to the location, and serving a sponsored content item to the user based on information from the registering, the sponsored content item including information from the message.

### BACKGROUND

This specification generally relates to information presentation.

Users can employ mobile phones and Short Message Service (SMS) technologies for sending and receiving text messages. Some mobile-based systems include Global Positioning System (GPS) technology that can determine a user's current location. Based on the user's location, relevant content may be provided to the user.

### SUMMARY

In general, one innovative aspect of the subject matter described in this specification may be embodied in methods, systems, and computer program products for serving content based on online registration and offline messages. One example method includes registering online an entity with a content management system, the registering including storing a location associated with the entity, receiving offline from the entity a message that indicates information for use in a sponsored content item, determining that a user is in proximity to the location, and serving a sponsored content item to the user based on information from the registering, the sponsored content item including information from the message.

In general, another example method includes receiving registration information for an entity that wants to generate instant content, receiving from the entity a message that specifies information for inclusion in a sponsored content item, automatically creating the sponsored content item including a title, information included in the message and a link, and delivering the sponsored content item to users located in proximity to or having expressed an interest in a location associated with the entity.

In general, another example method includes determining that a user is in proximity to or has expressed interest in a specific location, determining an entity associated with the specific location, identifying an offline message received from the entity that includes a message for the user, constructing a sponsored content item including the message, and delivering the sponsored content item including the message to the user.

In general, another innovative aspect of the subject matter described in this specification may be embodied in computer program products that include instructions that when executed by one or more computers cause the one or more computers to perform operations including registering online an entity with a content management system, the registering including storing a location associated with the entity, receiving offline from the entity a message that indicates information for use in a sponsored content item, determining that a user is in proximity to the location, and serving a sponsored content item to the user based on information from the registering, the sponsored content item including information from the message.

In general, another innovative aspect of the subject matter described in this specification may be embodied in systems that include a content management system for serving sponsored content to users and an auction manager. The content management system can include an online registration manager, a message parser, a proximity detector, a content item creator, and a content item server. The online registration manager can register online an entity with a content management system, the registering including storing a location associated with the entity. The message parser can parse a message received offline from the entity, the message including information for use in a sponsored content item. The proximity detector can determine that a user is in proximity to the location. The content item creator can automatically create the sponsored content item based on information from the registering and including information from the message. The content item server can serve the sponsored content item to the user. The auction manager can conduct an auction including determining one or more winning bids.

These and other embodiments may each optionally include none, one or more of the following features. An auction can be conducted, including determining one or more winning bids. The information included in the message can include bid information, and serving the sponsored content item can include serving the sponsored content item when it represents one of the winning bids. The sponsored content item can be served within a time range, and the message can include time sensitivity information for serving the sponsored content item. The message can be parsed to determine parameters for use in serving the sponsored content item. The parameters can include bid information. The parameters can include time sensitivity information. The message can be a text message, a phone message, a micro-blogging message, or a blog posting. The content for use in the sponsored content item can include an image. The entity can be a business and registering can include storing a business location and one or more serving parameters for content items sponsored by the business. The serving parameters can include one or more regions for serving sponsored content items to users. The serving parameters can include a flat rate bid, a maximum bid, or a maximum spend. The entity can be sent a status report related to a cost of serving sponsored content items to users.

Particular embodiments of the subject matter described in this specification may be implemented to realize none, one or more of the following advantages. Entities can create campaigns by providing offline messages after registering online, enabling an entity to quickly capitalize on potential opportunities. Entities can monitor and control time-sensitive (e.g., short-term) campaigns based on immediate campaign results, using mobile devices.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a diagram of an example system that can register entities with a content management system and serve content associated with the entities to users.

FIG. 2 shows an example user interface for registering entities.

FIGS. 3-5 are flowcharts of example processes for registering entities, generating content associated with the entities, and serving the content to users.

FIG. 6 shows an example of a computer device and a mobile computer device that can be used to implement the techniques described herein.

Like reference symbols in the various drawings indicate like elements.

### DETAILED DESCRIPTION

In general, computer systems can register entities (e.g., organizations, individuals, businesses, etc.), can generate content (e.g., sponsored content including visual, audio, and/or text elements), and can serve content to users. For example, an entity can use an online interface (e.g., a web page) to provide registration information for the entity to a content management system. The registration information can include location information for the entity (e.g., the entity's address). After registering, for example, the entity can use a second, different, offline interface (e.g., a mobile phone texting interface, a voicemail interface, a blogging interface, etc.) to provide information that specifies or can be used to generate content to be presented to users that are either proximate to the entity's location or express an interest in the location. Offline interfaces, for example, may be accessed by various types of devices, including client computing devices (e.g., stationary or portable devices, such as smartphones) and/or non-computing devices (e.g., a regular telephone accessing a voicemail system). Information provided via the online registration process and via the offline message specification can be used to automatically create content for presentation to users. When a user is detected as being in proximity to (e.g., within a predefined range or area) or as having interest in the location specified by the entity, for example, content based on the registration information and the message can be served to the user.

The systems discussed here may provide one or more mechanisms for collecting information about users. Users may be provided with an opportunity to opt in/out of programs that may collect personalized information. For example, a user may receive notice of what data may be collected and how such data may be used or retained, subject to the user's express permission. A user's location, for example, may not be used without the user's informed consent. In addition, certain data may be anonymized in one or more ways before it is stored or used, so that personally identifiable data is removed.

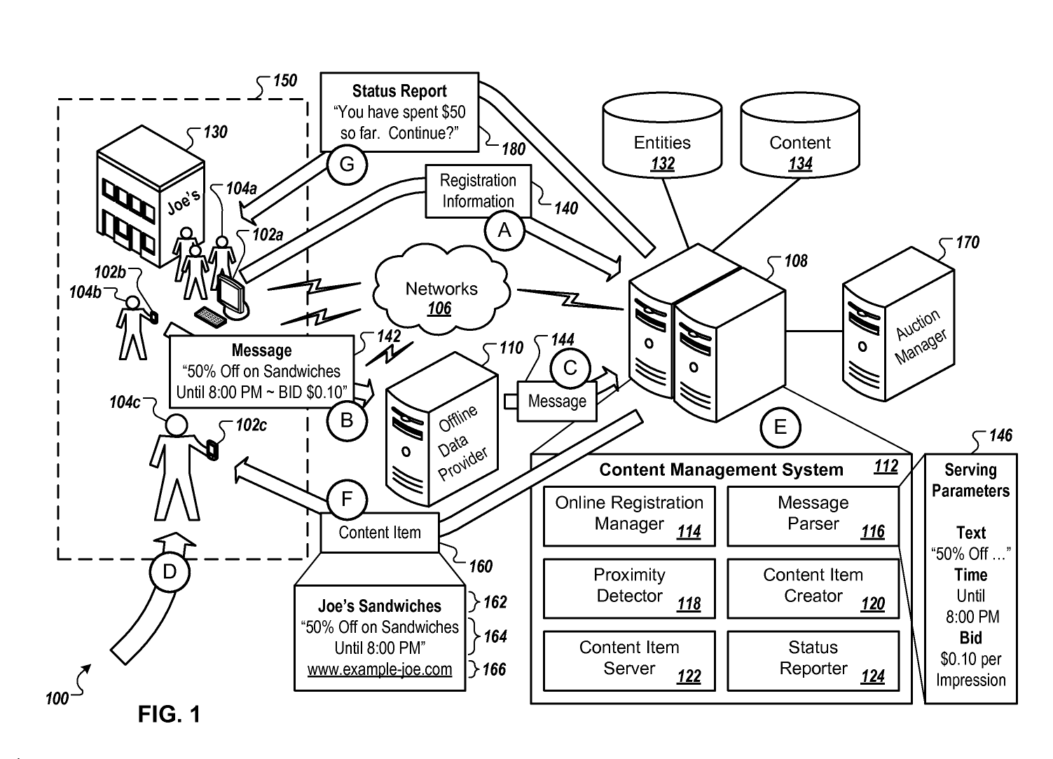

FIG. 1 is a diagram of an example system 100 that can register entities and serve content associated with entities to users. FIG. 1 also illustrates an example flow of data within the system 100 during states (A) to (G), where the states (A) to (G) may occur in the illustrated sequence, or they may occur in a sequence that is different than in the illustrated sequence. For example, two or more of the states (A) to (G) may occur concurrently.

In further detail, the system 100 includes one or more client devices 102 (each operated by a corresponding device user 104) that communicate over one or more networks 106 with one or more computing servers 108 and/or one or more servers associated with offline data providers (e.g., an offline data provider 110). The networks 106 may include a wireless cellular network, a wireless local area network (WLAN) or WiFi network, a Third Generation (3G) or Fourth Generation (4G) mobile telecommunications network, an intranet, the Internet, or any other suitable network or any appropriate combination thereof.

The client device(s) 102 may be any suitable type of computing device (e.g., mobile phone, smartphone, personal digital assistant, tablet computer, laptop or desktop computer, or other stationary or portable device) that includes one or more processors and computer readable media. Among other components, for example, the client device(s) 102 includes one or more processors, computer readable media that store software applications, input device(s) (e.g., touch screens, keyboards, computer mice, motion sensors, microphones, etc.), output device(s) (e.g., display screens, speakers, etc.), and communications interfaces.

The computing server(s) 108 may be configured to execute application code associated with a variety of software components (e.g., modules, objects, libraries, services, etc.), including computer instructions to perform some or all of the method steps described below. In some implementations, the computing server(s) 108 may include one or more components of a content management system 112 described below.

The content management system 112 can register entities (e.g., an entity 130, “Joe's Sandwiches”) using information provided by entity representatives (e.g., the device users 104a, 104b) via an online interface, and can receive message information from the entity representatives via one or more offline interfaces and data providers. Using the registration information and message information, for example, the content management system 112 can generate content, and can provide the content to system users (e.g., the device user 104c).

The content management system 112 can register entities, can generate content, and can serve content to users. The content management system 112 can include an online registration manager 114, a message parser 116, a proximity detector 118, a content item creator 120, a content item server 122, and a status reporter 124, for example. Two or more of the components 114, 116, 118, 120, 122, and 124 may be implemented on the same device (e.g., same computing device), or on different devices, such as devices included in a server farm or a peer-to-peer network. The content management system 112 and server(s) 108 can be in communication with one or more data storage devices, including an entities data store 132 and a content data store 134. The data stores 132, 134 can implement databases, file systems, and the like to add, remove, and maintain data used by the system 100.

Referring to the example flow of data, during state (A), an entity representative can register an entity with the content management system 112. Entity representatives, for example, may include various individuals associated with entities, such as owners, employees, contractors, consultants, agents, and other such individuals. In the present example, the device user 104a (e.g., an employee of “Joe's Sandwiches”) can employ the client device 102a to interact with an online interface (e.g., a web page) of the content management system 112 to provide registration information 140 for the entity 130. The registration information 140, for example, may include information such as entity location information (e.g., an address, a defined region, etc.), entity contact information (e.g., names, phone numbers, web links, etc.), and information for sponsoring content (e.g., advertisements) to be provided to system users. Upon receiving the registration information 140, for example, the content management system 112 can employ the online registration manager 114 to add, update, and remove information associated with the entity 130 from the entities data store 132.

During state (B), an entity representative can provide information for use in generating content to be presented to users. In the present example, the device user 104b (e.g., an owner of “Joe's Sandwiches”) can employ the client device 102b to interact with an offline interface (e.g., an interface to an application such as a text messaging application, a voicemail application, a blogging application, etc.) associated with the offline data provider 110. Offline data providers, for example, may include providers of communication services such as text messaging, voicemail, blogging, and other services which are “offline”, or separate from entity registration and content providing services of the content management system 112. Using the offline interface, for example, the user 104b can provide information including a message 142 including message text (e.g., “50% off on sandwiches until 8:00 PM”) for presentation to users in proximity to or interested in the location of the entity 130.

During state (C), message information can be received by the content management system 112. For example, upon receiving the message 142 from the client device 102b, the offline data provider 110 can forward the received message 142 (here shown as message 144) to the computing server(s) 108 and the content management system 112 via the networks 106. As another example, the offline data provider 110 can host information associated with the message 142, and the content management system 112 can periodically retrieve messages from the offline data provider 110 using an applications programming interface (API), a web scraping technique, or another suitable technique for collecting offline data.

Upon receiving messages, for example, the messages may be parsed to determine parameters for use in serving content to system users. In the present example, the content management system 112 can employ the message parser 116 to parse the message 144 to determine serving parameters 146. Serving parameters, for example, may include parameters such as message text (e.g., messages to users may include a text and/or audio phrase “50% off on sandwiches until 8:00 PM”), time sensitivity parameters (e.g., messages may be delivered to users from the present time until 8:00 PM), bid parameters (e.g., a bid of $0.10 per impression) and other suitable serving parameters. To parse the serving parameters 146 from the message 144, the message parser 116 can use grammar-based and/or statistical (e.g., machine learned) techniques, for example. In some implementations, keywords and/or delimiting characters may be used to indicate particular parameters. For example, a special character (e.g., a tilde) could be used to indicate a message text boundary, and a keyword (e.g., “BID”) followed by a value may be used to indicate a parameter such as a bid amount. Upon parsing the serving parameters 146, for example, the content management system 112 can store the parameters at the content data store 134.

During state (D), a determination can be made that a system user is in proximity to or interested in the location specified by the entity during registration. For example, the client device 102c employed by the device user 104c may include location identification capabilities such as Global Positioning System (GPS) capabilities, WiFi triangulation capabilities, or other such capabilities that can provide a device location to the content management system 112. With express permission from the user 104c, for example, the content management system 112 may employ the proximity detector 118 to use location information provided by the client device 102c to determine whether the user 104c is within a region 150 previously specified by the entity 130. As another example, the content management system 112 may receive information associated with one or more queries provided by the user 104c to a search engine or map provider (not shown) to determine whether the user is interested in the entity 130 and/or the region 150. In still further examples, a location of the user can be determined based on other information (e.g., using an IP address, or as a result of a check in by the user).

During state (E), content can be created by the content management system 112, based, for example, on registration information and message information provided by entity representatives. In the present example, upon determining that the user 104c is located within (or interested in) the region 150, the content management system 112 can reference the registration information 140 (e.g., information provided by the device user 104a during state (A)) from the entities data store 132, and can reference information associated with the message 144 (e.g., information provided by the device user 104b during state (B)) from the content data store 134. Based on the registration information 140 and the message 144, for example, the content management system 112 can employ the content item creator 120 to generate content (e.g., a content item such as a digital advertisement including visual, audio, and/or text elements) for presentation to the user 104c.

During state (F), content can be served to users by the content management system 112. The content management system 112 can employ the content item server 122, for example, to provide a content item 160 (e.g., an advertisement) to the client device 102c via networks 106, for presentation to the device user 104c. In the present example, the content item 148 includes an entity identifier 162, (e.g., “Joe's Sandwiches”), message text 164 (e.g., “50% off on sandwiches until 8:00 PM”), and a web link 166 (e.g., “www.example-joe.com”). The entity identifier 162 and the web link 166, for example, may be provided by a representative (e.g., device user 104a) of the entity 130 as part of an online registration process. The message text 164, for example, may be provided by the same representative that provided the registration information, or by a different representative (e.g., device user 104b) of the entity 130 as part of an offline messaging process.

In some implementations, a process used to determine content for serving to users may include cost and/or quality considerations. For example, multiple entities may specify similar locations, and may provide bids for having content (e.g., advertisements) served to users who are in proximity to and/or interested in the similar locations. Bid information from various entities can be received and processed by a server associated with an auction manager 170, for example. Based on an auction, the auction manager 170 may assist in the selection of content to be served. In some implementations, quality considerations may influence content selection. For example, if the content item 160 and/or entity 130 is associated with a higher click-through rate (CTR) than other content items and/or other entities participating in an auction, a bid associated with the content item 160 may receive a boost (e.g., as a percentage, a fixed value, etc.) by the auction manager 170 when conducting the auction.

In some implementations, content items may be presented in association with content requested by a user, such as search query results, map query results, etc. For example, if the user 104c were to submit a search query including a particular keyword or keywords (e.g., “sandwich”) while located within the region 150, the content item 160 may be provided in association with (e.g., in the same display area, superimposed on, preceding, following, etc.) search results pertaining to the submitted query. In some implementations, content items may be presented automatically, outside of the context of a user request. For example, the client device 102c may include a device application which prompts the user 104c upon receiving content items served by the content management system 112. Upon viewing the content item 160, for example, the user 104c may follow the web link 166 to receive additional information about “Joe's Sandwiches”, and may visit “Joe's Sandwiches” for purchasing a sandwich.

During state (G), status information may be provided to entities. For example, the content management system 112 can employ the status reporter 124 to identify statistical information (e.g., counts, costs, etc.) associated with serving content items to users, and can provide the statistical information to entity representatives (e.g., content sponsors) at predefined intervals. For example, statistical information may be provided at predefined time intervals (e.g., hourly, every half hour, etc.), may be provided when a spending threshold (e.g., $50, $100, etc.) has been reached, and/or may be provided when a quantity threshold (e.g., 100 content items served, 200 content items served, etc.) has been reached. In the present example, a representative (e.g., the device user 104a and/or 104b) of the entity 130 may receive a status report 180 (e.g., “You have spent $50 so far. Continue?”) from the content management system 112 via the networks 106, at one or more client devices (e.g., the client device 102a and/or 102b).

In the present example, based on the status report 180, the representative may elect to continue or to end a campaign. For example, “Joe's Sandwiches” may not have experienced an increase over normal customer traffic after having spent fifty dollars for providing sponsored content (e.g., advertisements) to users. Thus, the representative may elect to end the campaign, or may elect to adjust the campaign by sending a different message to the content management system 112. As another possibility, “Joe's Sandwiches” may have experienced a great increase over normal traffic, and the representative may elect to continue the campaign. By receiving and responding to status reports delivered at predefined intervals, for example, an entity representative can monitor and modify time-sensitive (e.g., short-term) campaigns based on immediate campaign results. As entities may provide registration information and message information at different times using different client devices, for example, once an entity has registered with the content management system 112, the entity can quickly and easily create and adjust (e.g., extend, cancel or modify) campaigns by providing offline messages, enabling the entity to capitalize on opportunities as they may arise.

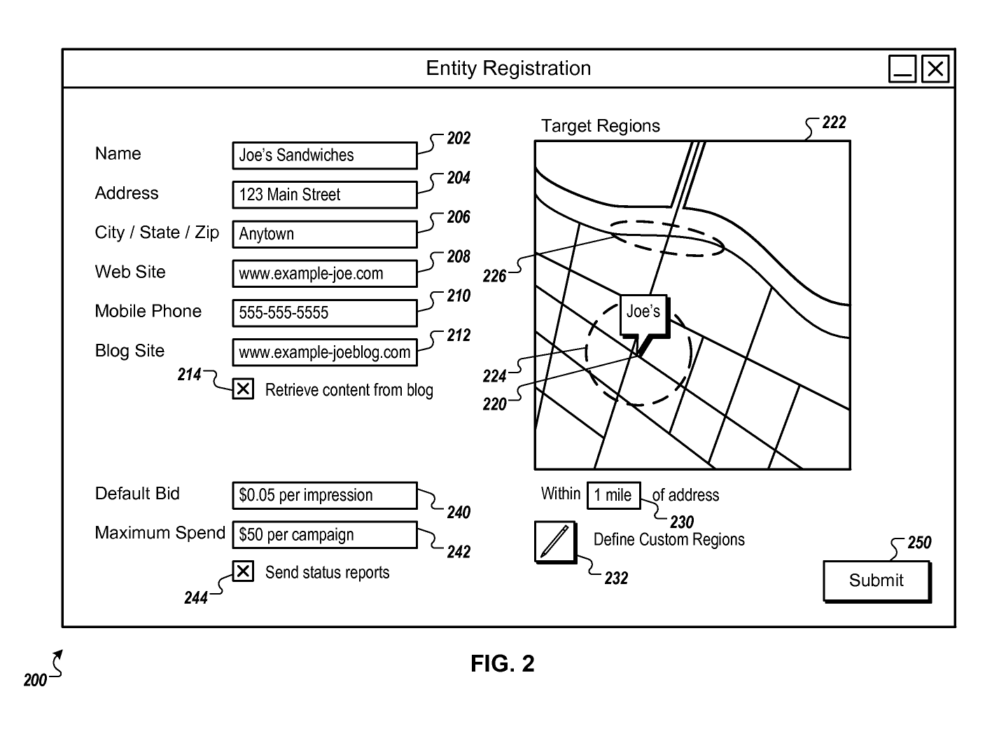

FIG. 2 shows an example user interface 200 for registering entities. For example, the client device 102a (shown in FIG. 1) can execute an application (e.g., a web browser) to present the user interface 200 to the device user 104a (e.g., a representative of the entity 130). By interacting with an online interface such as the user interface 200, for example, the user 104a can provide the registration information 140 to the computing server(s) 108 and the content management system 112.

The user interface 200 can include controls for specifying information associated with entities and/or campaigns (e.g., advertising campaigns) for providing content (e.g., advertising content) to users. For example, the entity 130 may be a business such as a sandwich shop (e.g., “Joe's Sandwiches”) seeking to run short-term promotions targeted to local customers. Perhaps “Joe's Sandwiches” is located nearby a baseball stadium, and its owner intends to promote and sell sandwiches to people who may be arriving at or leaving ball games. By providing up-front information about “Joe's Sandwich”, its desired customers, and default campaign parameters, for example, the owner or another representative of “Joe's Sandwiches” can quickly launch a campaign at a future time (e.g., an hour before game time, immediately after game time, etc.) by providing minimal information using an offline interface (e.g., a text messaging application, a voicemail application, a blogging application, etc.).

The user interface 200 can include one or more controls for specifying entity contact information. In the present example, a control 202 is included for specifying an entity's name (e.g., “Joe's Sandwiches”), a control 204 is included for specifying an entity's address (e.g., “123 Main Street”), a control 206 is included for specifying an entity's city/state/zip (e.g., “Anytown”), a control 208 is included for specifying an entity's web site (e.g., “www.example-joe.com”), a control 210 is included for specifying an entity's mobile phone number (e.g., “555-555-5555”), and a control 212 is included for specifying an entity's blog site (e.g., “www.example-joeblog.com”). More or fewer controls may be used specifying entity contact information, for example, and more or less information may be specified.

In some implementations, one or more of the controls 202, 204, 206, 208, 210, and 212 may be used for purposes other than or in addition to providing entity contact information. In addition to indicating entity contact information, for example, information received by the content management system 112 via controls 202, 204, 206, 208, 210, and 212 may be used for generating content to be presented to users. Some or all of the entity contact information may be merged with information associated with offline messages provided by the entity to automatically generate content, for example.

As another example, in addition to indicating entity contact information, information received via controls 208, 210, and 212 (e.g., web site, mobile phone, and blog site) may be used by the content management system 112 for receiving and/or retrieving offline message information, and/or for reporting campaign status. For example, the content management system 112 can reference an entity's mobile phone number to identify the entity when receiving offline messages (e.g., text messages) from an offline data provider (e.g., a text messaging provider). As a campaign progresses, for example, the content management system 112 can reference the entity's mobile phone number to send status updates to the user's client device (e.g., a smartphone) via text messages and/or a dedicated reporting application executed by the device.

As shown in the present example, a control 214 is included for an entity representative to provide permission to retrieve information from the entity's blog (e.g., www.example-joeblog.com). Instead of or in addition to providing messages to the content management system 112 via a text messaging interface, for example, an entity representative may update the entity's blog to include messages for users (e.g., “A free soda if you bring in a ticket stub from today's game!”). If the control 214 is selected, for example, the content management system 112 may retrieve a message from the entity's blog and may create a content item (e.g., an advertisement) including the message for serving to users. As another example, information can be retrieved from other sources, such as an activity stream associated with an entity in a social network, or from an entity sponsored content site or page in a network (e.g., in a social network).

In addition to indicating entity contact information, for example, information received via controls 202, 204, and 206 (e.g., name, address, and city/state/zip) may be used by the content management system 112 to locate an entity. For example, the content management system 112 can provide location-related information to a mapping system (not shown) for identifying an entity's location 220 on a map 222. As shown in the present example, the map 222 including the location 220 may be presented by the interface 200 to facilitate the specification of one or more target regions (e.g., target regions 224, 226) by an entity representative using one or more controls. For example, target region 224 (e.g., a local neighborhood) may be defined by an entity representative through use of a control 230 for providing a distance (e.g., one mile) from the location 220 (e.g., a storefront of “Joe's Sandwiches”). As another example, an entity representative may interact with a control 232 (e.g., a graphics tool) for defining custom regions to specify target region 226 (e.g., an area around a nearby baseball stadium). If a user is detected (e.g., by the proximity detector 118, shown in FIG. 1) as being within the target region 224 or the target region 226, or is detected as expressing interest in either of the regions 224, 226, for example, the content management system 112 may serve content to the user (where the content is associated with the entity).

The user interface 200 can include one or more controls for specifying information for sponsoring content. In the present example, a control 240 is included for specifying default bid information (e.g., $0.05 per impression), a control 242 is included for specifying maximum spend information (e.g., $50 per campaign), and a control 244 is included for specifying whether or not the content management system 112 is to send status reports. The default bid information specified by control 240, for example, may be used by the auction manager (shown in FIG. 1) for conducting an auction for serving content to users. As content is served during a campaign, for example, the content management system 112 can track campaign status (e.g., the amount spent by an entity, the number of content items served, etc.) and can either terminate a campaign when a particular threshold is reached (e.g., the amount spent or number of impressions reaches a certain value), or may provide a campaign status report prompting an entity representative to continue, modify, or discontinue the campaign.

The user interface 200 can include one or more controls for submitting registration information (or changes to registration information). Upon providing and/or modifying registration information, an entity representative may submit the information to the content management system 112, for example, by interacting with a submission control 250. Upon receiving registration information associated with an entity, for example, the content management system 112 can maintain the information at the entities data store 132 for future use.

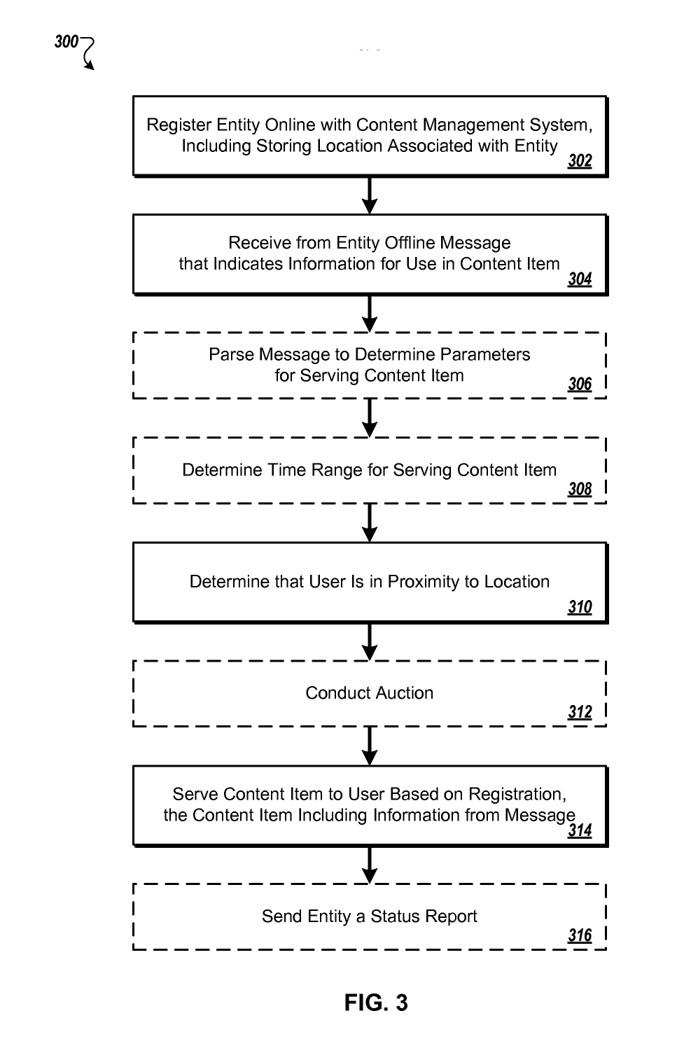

FIG. 3 is a flowchart of an example process 300 for registering entities, generating content associated with the entities, and serving the content to users. In some implementations, the process 300 may be performed by the system 100 and will be described as such for the purpose of clarity. Briefly, the process 300 includes registering an entity online with a content management system (including storing a location associated with the entity), receiving from the entity an offline message that indicates information for use in a content item, optionally parsing the message to determine parameters for serving the content item, optionally determining a time range for serving the content item, determining that a user is in proximity to the location, optionally conducting an auction, serving the content item (including information from the message) to the user based on the registration, and optionally sending the entity a status report.

An entity can be registered (302) online with a content management system. For example, the entity 130 can be registered online with the content management system 112 via the online registration manager 114 and a registration interface (e.g., the user interface 200, shown in FIG. 2) provided to the client device 102a operated by the user 104a. The registering can include storing a location associated with the entity. For example, using the interface 200, the user 104a can specify registration information 140 including a location (e.g., an address) of the entity 130, and can submit the registration information 140 to the content management system 112. In some implementations, location information for an entity may be derived from other information or sources. Upon receiving submitted registration information 140, for example, the content management system 112 can store the information (including location information) at the entities data store 132.

In some implementations, the entity may be a business and registering may include storing a business location and one or more serving parameters for content items sponsored by the business. For example, the entity 130 may be a neighborhood business such as “Joe's Sandwiches”. During registration, for example, a representative of “Joe's Sandwiches” (e.g., a manager) can provide a storefront address, and additional serving parameters for content items (e.g., sandwich advertisements) to be served to potential customers. Serving parameters may include one or more regions for serving sponsored content items. Referring to FIG. 2, for example, the entity representative may define target regions 224 (e.g., an area around the storefront of “Joe's Sandwiches”) and 226 (e.g., an area around a nearby baseball stadium). Serving parameters may include flat rate bids, maximum bids, and/or maximum spend amounts. Referring to FIG. 2, for example, the entity representative may specify via control 240 that a default auction bid of $0.05 is to be provided for having content items served to users. Moreover, in the present example, the entity representative may specify via control 242 that a maximum amount of fifty dollars is to be spent for serving content items during a campaign.

A message can be received (304) offline from the entity. For example, a representative (e.g., the user 104a or the user 104b) of the entity 130 can send the message 142 to the offline data provider 110, which can in turn provide the message 144 to the content management system 112. A message can indicate information for use in creating a sponsored content item. For example, the message 142 may include the message string “50% off on sandwiches until 8:00 PM˜BID $0.10”. The message 142, for example, may be a text message, a phone message, a micro-blogging message, a blog posting, a social network posting, or another sort of offline message. To provide text messages, for example, entity representatives may use client devices such as smartphones to generate the messages, and may use a short code or phone number associated with the content management system 112 to send the messages to the system 112 via an offline data provider (e.g., a mobile network carrier). To provide phone messages, for example, entity representatives may use telephones such as landline phones, mobile phones, or smartphones to call a voice mailbox or interactive voice response system associated with the content management system 112, hosted by an offline data provider (e.g., a voicemail system). To provide micro-blogging messages, blog postings or social update postings, for example, entity representatives may use client devices to access offline data providers of micro-blogging, blogging services or social application services. The content management system 112 can receive and/or retrieve messages from offline data providers (e.g., the offline data provider 110) using a variety of techniques and protocols, such as by way of application programming interfaces (APIs).

The message may optionally be parsed (306) to determine parameters for use in creating and/or serving the sponsored content item. For example, the message 142 can be parsed to determine serving parameters 146 such as message text (e.g., “50% off on sandwiches until 8:00 PM”), time sensitivity information (e.g., “until 8:00 PM”) and/or bid information (e.g., “BID $0.10”). The message parser 116 can use grammar-based and/or statistical (e.g., machine learned) techniques, for example, to parse the message 142. For voice-based messages, for example, voice recognition techniques may be used to convert a voice signal to text prior to parsing the messages. For messages received via offline voice response systems, for example, one or more parameters may be directly provided. For example, while interacting with a voice response system, a user may be prompted to provide particular parameters in turn (e.g., “Please state your message text.”, “Please enter a bid amount.”, etc.) using keypad or voice input, and the voice response system can provide the parameters to the content management system 112 when the input process is complete. Upon receiving and/or parsing the serving parameters 146, for example, the content management system 112 can store the parameters at the content data store 134.

A time range for serving the content item may optionally be determined (308). In the present example, the time range may be determined from the time sensitivity information (e.g., “until 8:00 PM”) included in the serving parameters. Thus, in the present example, content items may be served from the time the message 144 is received by the content management system 112 until the time associated with the time sensitivity parameter (e.g., 8:00 PM). As another example, time sensitivity information may be excluded from the message 142, and content items may be served until a default time (e.g., a time of day designated by an entity representative during registration), until another threshold (e.g., a spending and/or quantity threshold) is reached, or until an entity representative explicitly terminates a campaign.

A determination (310) can be made that a user is in proximity to (or interested in) the location. For example, the client device 102c of the device user 104c (e.g., a potential customer of “Joe's Sandwiches”) can include Global Positioning System (GPS) capabilities, WiFi triangulation capabilities, or other such capabilities for providing device location information to the content management system 112. Upon receiving device location information, for example, the proximity detector 118 may determine that the device user 104c (e.g., a potential customer of “Joe's Sandwiches”) is within either the target region 224 (e.g., an area around a storefront for “Joe's Sandwiches”) or the target region 226 (e.g., an area around a nearby baseball stadium).

An auction may optionally be conducted (312). In the present example, the entity 130 may be associated with a default bid (e.g., $0.05 per impression) included in the registration information 140 provided during an online registration process, or with a bid (e.g., $0.10 per impression) included in the offline message 144. As the bid included in the offline message 144 relates to a particular campaign, for example, the bid (e.g., $0.10 per impression) may be used in an auction for that campaign. Thus, an entity representative may influence (e.g., increase, decrease) potential audience reach during particular campaigns, for example, by providing different (e.g., higher, lower) bids than indicated by a default value. When conducting the auction, for example, the auction manager 170 may determine one or more winning bids from bids provided by various entities (e.g., content sponsors), and content items associated with an entity may be served when they represent one of the winning bids.

The sponsored content item can served (314) to a user, based on information from the registering, and/or including information from the message. For example, the content item creator 120 can create the content item 160 including the entity identifier 162 (e.g., “Joe's Sandwiches”) and web link 166 (e.g., “www.example-joe.com”) included in the registration information 140, and including the message text 164 (e.g., “50% off on sandwiches until 8:00 PM”) included in the message 144. In some implementations, content for use in the sponsored content item may include an image. For example, a representative of the entity 130 may use the client device 102a to upload a particular graphic (e.g., a company logo for “Joe's Sandwiches”) as part of an online registration process. In the present example, when creating content items for serving to users, the content item creator 120 may include the graphic (e.g., logo) across multiple campaigns. As another example, a representative of the entity 130 may use the client device 102b to send a multimedia text message including a photo (e.g., of a particularly appetizing sandwich), along with other serving parameters, intended for use in content items associated with a particular campaign. Upon generation and/or retrieval of the content item 160, for example, the content item server 122 can serve the content item 160 to the client device 102c for presentation to the device user 104c. Content items, for example, may be presented in association with information requested by a user (e.g., search query results, map query results, etc.), or may be presented by a device application which automatically prompts the user upon receiving content items or upon the user arriving at a given location.

A status report related to a cost of serving sponsored content items may optionally be sent (318) to the entity. For example, the status reporter 124 can send status reports (e.g., status report 180) to one or more client devices (e.g., client devices 102a, 102b) associated with the entity 130. Status reports, for example, may include information regarding the current status (e.g., duration, cost of content items served, number of content items served, etc.) of a campaign, and may be sent at various predetermined intervals (e.g., time intervals, the crossing of cost thresholds, the crossing of number of items served thresholds, etc.). In the present example, the status report 180 includes a message (e.g., “You have spent $50. Continue?”) for a representative of the entity 130. If the entity representative elects to continue the campaign, for example, he or she may reply to the status report 180 (e.g., by sending a “Y” via text message). If the entity representative elects to end the campaign, for example, he or she may reply to (e.g., by sending “N”) or may ignore the status report 180. Thus, for example, entity representatives may use mobile devices to create, monitor, and control campaigns for serving content to users.

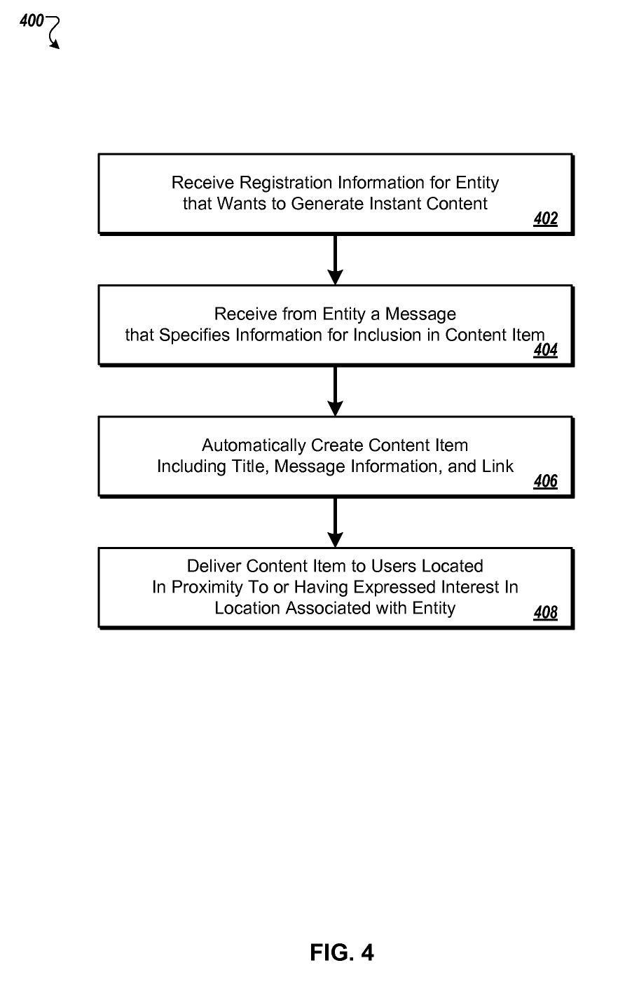

FIG. 4 is a flowchart of an example process 400 for registering entities, generating content associated with the entities, and serving the content to users. In some implementations, the process 400 may be performed by the system 100 and will be described as such for the purpose of clarity. Briefly, the process 400 includes receiving registration information for an entity that wants to generate instant content, receiving from the entity a message that specifies information for inclusion in a content item, automatically creating a content item including a title, message information, and a link, and delivering the content item to users located in proximity to or having expressed interest in a location associated with the entity.

Registration information can be received (402) for an entity that wants to generate instant content. For example, the entity 130 (e.g., “Joe's Sandwiches”) may want to generate instant content to inform potential customers about a new offering (e.g., “BBQ chips arrived today!”). A message that specifies information for inclusion in a sponsored content item can be received (404) from the entity. For example, a representative of the entity 130 can use his or her smartphone to send the content management system 112 a text message including message text (e.g., “BBQ chips arrived today!”), and other information for inclusion in a sponsored content item.

The sponsored item can be automatically created (406). For example, the content item creator 120 can create a content item including a title, information included in the message, and a link. In some implementations, content items may be created by merging information included in the message with information previously provided by the entity during a registration process. For example, a representative of the entity 130 may have previously specified title and/or link information to be used by the content item creator 120 for creating content items associated with received messages. In some implementations, content items may be created solely based on information included in a message. For example, a representative of the entity 130 may provide a message including a title, message text, and link information.

The sponsored content item can be delivered (408) to users located in proximity to or having expressed an interest in a location associated with the entity. For example, the content item server 122 can deliver content items created by the content item creator 120 to users who are located in proximity to the entity 130. If a user were to be in proximity of the entity 130 at the time of content creation, or were to approach the entity after content creation, for example, the proximity detector 118 can notify the content item server 122 of such an occurrence, and the content item server 122 can serve content to the user. As another example, the content item server 122 can deliver content items to users who users who search for the location of the entity 130 (e.g., by specifying an address at or near the entity's address in a map search) or for features in proximity to the entity location.

Location information may be provided by entities to the content management system 112 in various ways. In some implementations, location information may be provided for an entity during a registration process. For example, a representative of the entity 130 may provide location information (e.g., an address, coordinates, etc.) for the entity. In some implementations, location information may be included in a message, or may be provided during a messaging process. For example, upon receiving the message 142, the offline data provider 110 may identify the location of a sending device (e.g., the client device 102b), and may provide device location information to the content management system 112 with the message 144. As another example, upon receiving the message 144, the content management system 112 may use the proximity detector 118 to determine the location of the sending device (e.g., the client device 102b). Thus, for example, location information for an entity may be explicitly provided by the entity, or may be determined by the content management system 112.

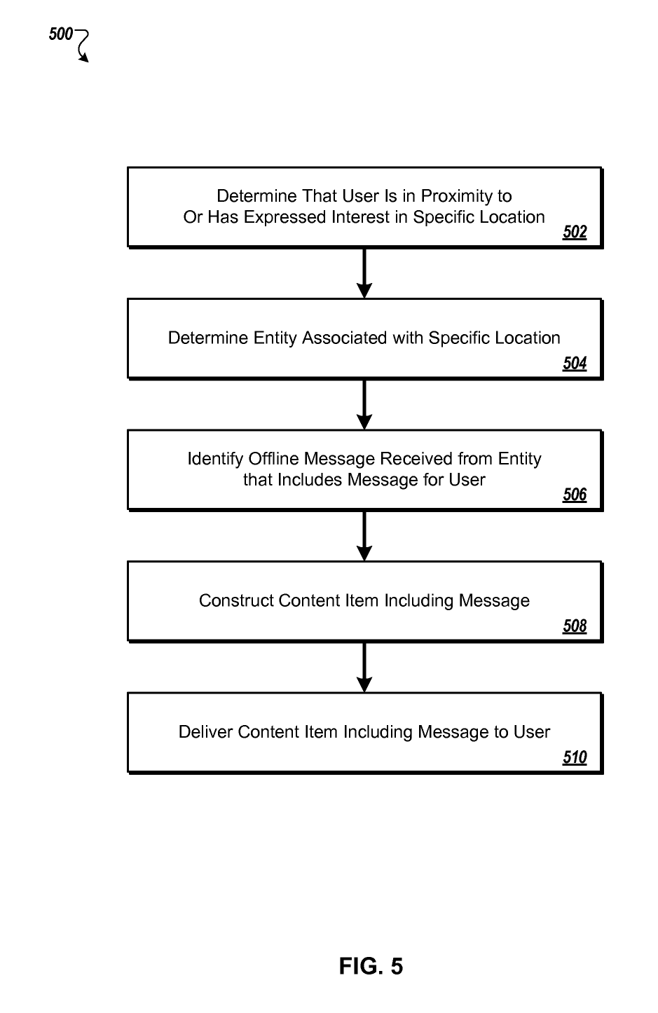

FIG. 5 is a flowchart of an example process 500 for registering entities, generating content associated with the entities, and serving the content to users. In some implementations, the process 500 may be performed by the system 100 and will be described as such for the purpose of clarity. Briefly, the process 500 includes determining that a user is in proximity to or has expressed interest in a specific location, determining an entity associated with the specific location, identifying an offline message received from the entity that includes a message for the user, constructing a content item including the message, and delivering the content item including the message to the user.

It can be determined (502) that a user is in proximity to or has expressed interest in a specific location. For example, the content management system 112 may receive a request for content from the device user 104c who is in proximity to (e.g., as determined by the proximity detector 118) or interested in (e.g., as determined by a search string) the location 220 (shown in FIG. 2). For example, the device user 104c can use an application executed by the client device 102c to provide a search string including a particular location (e.g., “Show me places to eat near Main Street.”). As another example, the device user 104c can use the device application to provide a search string pertaining to his or her current location (e.g., “Show me places to eat near me.”). In the request for content, for example, the client device 102c can include location information for the device. As another example, with the device user's 104c permission, the client device 102c may automatically provide device location information to the content management system 112. As the client device 102c enters the region 150, for example, the content management system 112 may determine or may be notified of the location of the device 102c.

An entity associated with the specific location can be determined (504). Upon receiving the request, for example, the content management system 112 can use the provided search string and/or device location information to identify one or more relevant entities from the entities data store 132. For example, entities may provide location information to the content management system 112 during a registration process, and such location information may be used to find matches for incoming requests.

An offline message received from the entity that includes a message for the user can be identified (506). Upon identifying one or more entities, for example, offline messages may be identified that have been previously received from the entities and that are maintained in the content data store 134. The messages, for example, may pertain to users in general, certain types of users (e.g., based on user demographics), or specific users (e.g., based on user login information and/or user device identifiers). In the present example, the entity 130 may have provided a message for users in general, to be delivered when a user is in proximity to or interested in the entity. The message, for example, may include an offer to “Try our new cheese sandwich today.”

A sponsored content item including the message can be constructed (508). For example, the content item creator 120 can use the message information and information provided by the entity 130 during a registration process to create a content item including the message (e.g., “Try our new cheese sandwich today.”). Other information provided by the entity 130, such as the entity's name, contact information, hours of operation, location information, etc., can be included in the content item. The content item, for example, may include visual, audio, and/or text elements, and may be configured by the content item creator 120 for suitable presentation on the client device 102c.

The sponsored content item including the message can be delivered (510). For example, the content item server 122 can provide the created content item to the client device 102c for presentation to the device user 104c. Thus, in the present example, in response to a request (e.g., “Show me places to eat near me.”) the user 104c may receive a relevant response (e.g., “Try our new cheese sandwich today. Joe's Sandwiches at 123 Main Street. Open until 10:00 PM.”).

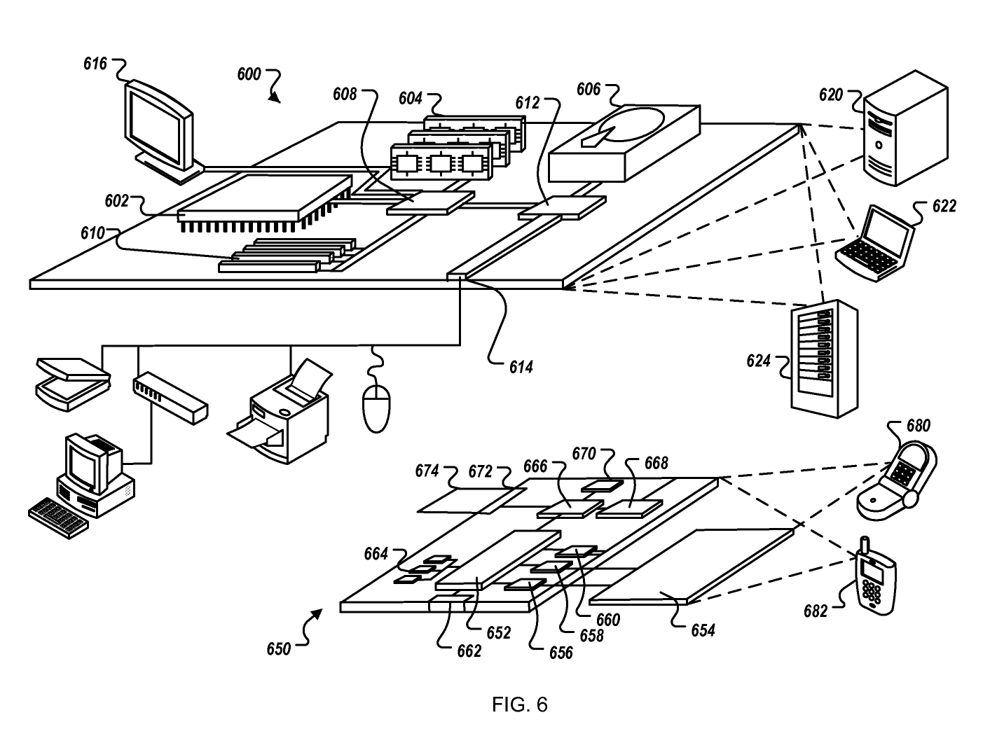

FIG. 6 shows an example of a generic computer device 600 and a generic mobile computer device 650, which may be used with the techniques described here. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, memory on processor 602, or a propagated signal.

The high speed controller 608 manages bandwidth-intensive operations for the computing device 600, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, memory on processor 652, or a propagated signal that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” or “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
registering, by one or more computing devices, online an entity with a content management system, the registering including storing, by the one or more computing devices, a location associated with the entity;
receiving, by the one or more computing devices, offline from the entity a message that indicates information for use in a sponsored content item;
determining, by the one or more computing devices, that a user is in proximity to the location based on device location information provided from a user device indicative of user device location; and
serving, by the one or more computing devices, a sponsored content item to the user based on information from the registering, the sponsored content item including information from the message;
wherein the message comprises bid information for use in conducting an auction for serving the sponsored content item.

2. The method of claim 1 further comprising conducting, by the one or more computing devices, the auction including determining, by the one or more computing devices, one or more winning bids, and wherein serving, by the one or more computing devices, the sponsored content item includes serving, by the one or more computing devices, the sponsored content item when it represents one of the winning bids.

3. The method of claim 1 further comprising determining that the sponsored content item is to be served within a time range, wherein the message includes time sensitivity information for serving the sponsored content item.

4. The method of claim 1 further comprising parsing, by the one or more computing devices, the message to determine parameters for use in serving the sponsored content item.

5. The method of claim 4 wherein the parameters include bid information.

6. The method of claim 4 wherein the parameters include time sensitivity information.

7. The method of claim 1 wherein the message is a text message, a phone message, a micro-blogging message, or a blog posting.

8. The method of claim 1 wherein the content for use in the sponsored content item includes an image.

9. The method of claim 1 wherein the entity is a business and wherein registering includes storing, by the one or more computing devices, a business location and one or more serving parameters for content items sponsored by the business.

10. The method of claim 9 wherein the serving parameters include one or more regions for serving sponsored content items to users.

11. The method of claim 9 wherein the serving parameters include a flat rate bid, a maximum bid, or a maximum spend.

12. The method of claim 11 further comprising sending the entity a status report related to a cost of serving sponsored content items to users.

13. A computer-implemented method comprising:
receiving, by one or more computing devices, registration information for an entity that wants to generate instant content;
receiving, by the one or more computing devices, from the entity a message that specifies information for inclusion in a sponsored content item, the message further comprising wherein the message comprises bid information for use in conducting an auction for serving the sponsored content item;
automatically creating, by the one or more computing devices, the sponsored content item including a title, information included in the message and a link; and
delivering, by the one or more computing devices, the sponsored content item to users located in proximity to or having expressed an interest in a location associated with the entity.

14. A computer-implemented method comprising:
determining, by the one or more computing devices, that a user is in proximity to or has expressed interest in a specific location;
determining, by the one or more computing devices, an entity associated with the specific location;
identifying, by the one or more computing devices, an offline message received from the entity that includes a message for the user, the message comprising wherein the message comprises bid information for use in conducting an auction for serving a sponsored content item;
constructing, by the one or more computing devices, the sponsored content item including the message; and
delivering, by the one or more computing devices, the sponsored content item including the message to the user.

15. A non-transitory computer storage medium encoded with a computer program, the computer program comprising instructions that when executed by one or more computers cause the one or more computers to perform operations comprising:
registering online an entity with a content management system, the registering including storing a location associated with the entity;
receiving of from the entity a message that indicates information for use in a sponsored content item, the message comprising information for use in conducting an auction for serving a sponsored content item;
determining that a user is in proximity to the location; and
serving the sponsored content item to the user based on information from the registering, the sponsored content item including information from the message.

16. The computer storage medium encoded with a computer program of claim 15, the computer program further comprising instructions that when executed by one or more computers cause the one or more computers to perform operations further comprising conducting an auction including determining one or more winning bids, wherein the information included in the message includes bid information, and wherein serving the sponsored content item includes serving the sponsored content item when it represents one of the winning bids.

17. The computer storage medium encoded with a computer program of claim 15, the computer program further comprising instructions that when executed by one or more computers cause the one or more computers to perform operations further comprising determining that the sponsored content item is to be served within a time range, wherein the message includes time sensitivity information for serving the sponsored content item.

18. The computer storage medium encoded with a computer program of claim 15, the computer program further comprising instructions that when executed by one or more computers cause the one or more computers to perform operations further comprising parsing the message to determine parameters for use in serving the sponsored content item.

19.-20. (canceled)
